(19) United States
(12) Patent Application Publication
(10) Pub. No.: US 2020/0077487 A1
(43) Pub. Date: Mar. 5, 2020

(54) SYSTEM FOR PROTECTION OF SOLID STATE ELECTRICAL DEVICES AGAINST OVER AND/OR UNDER VOLTAGE CONDITIONS

(71) Applicant: Greenstar Research and Development India Private Limited, Gurgaon (IN)

(72) Inventors: Tom Wright, Gurgaon (IN); Prajapati Dangwal, Gurgaon (IN); Sumant Mukherjee, Gurgaon (IN)

(73) Assignee: Greenstar Research and Development India Private Limited, Gurgaon (IN)

(21) Appl. No.: 16/549,105

(22) Filed: Aug. 23, 2019

(30) Foreign Application Priority Data
Aug. 24, 2018 (IN) 201811031729

(51) Int. Cl. H05B 33/08; H02H 3/20

(52) U.S. Cl. CPC H05B 33/0887; H05B 33/0809; H02H 3/207

(57) ABSTRACT

A system (100) for protection of solid state electrical devices against over and/or under voltage conditions, comprises an AC input (110), supplying an AC connected with fuse, AC filters (112), connected with the AC input (110) via the fuse, configured to filter the AC, rectifiers (114), connected with the AC filters (112), configured to convert the AC line voltage into DC line voltage thereby forming a DC bus voltage, buck converters (118), connected with the rectifiers (114), configured to step down the DC bus voltage thereby providing a first DC voltage, voltage dividers (116), connected with the rectifiers (114), configured to divide the DC bus voltage, thereby generating a second DC voltage, a threshold detector (120) connected with the buck converters (118) and the voltage dividers (116), a relay (122) connected with the threshold detector (120), the AC input (110) supplying the AC and one or more loads (124).

### FIELD OF INVENTION

The present invention generally relates to protection of electronic systems and more particularly to a system for protection of electrical devices against over and/or under voltage conditions.

### BACKGROUND OF INVENTION

High voltage transmission of electricity is highly unstable. A slight change in current intensity at this stage can result in high variation of current at domestic level use. Electrical/electronic device such as LED luminaires etc. have extremely small electronic components which possess sensitivity toward electrical current. The sensitive electrical/electronic device may underperform or get damaged due to fluctuation in current and eventually voltage on which the electrical device is working. This effect of overvoltage is a chronic failure mode.

Over voltage condition occurs when the voltage in a circuit or part of it is raised above its upper design limit. Under voltage condition occurs when the average voltage of drops below intended levels. Both over voltage condition and under voltage condition are likely to damage the circuitry of electrical device.

There are solutions available that provide protection against over voltage condition and under voltage conditions. Though, few of the available solutions are less sensitive to the electrical fluctuation and provide protection only against heavy fluctuations which is likely to affect heavy electrical/electronic devices.

The small electrical devices such as luminaires etc. are highly sensitive to electrical fluctuation and gets damaged under a little unstable voltage. The present solutions do not provide protection of light/smaller electrical/electronic devices such as individual luminaire (electrical lighting source) against over voltage conditions and under voltage conditions.

Therefore, there is a need in the art for a device/system for protection against over and/or under voltage conditions, does not suffer from above mentioned deficiencies or at least provide a viable alternative to mitigate for a longer time frame.

### OBJECT OF INVENTION

An object of the present invention is to provide a small autonomous system for protection of electrical devices against fluctuating electrical conditions.

Another object of the present invention is to protect electrical devices against over voltage condition.

Another object of the present invention is to protect electrical devices against under voltage condition.

Another object of the present invention is to provide configurable under and overvoltage limits as per the custom requirement.

Another object of the present invention is to provide an ease of exchange/replacement in case of failure while preventing catastrophic failure of sensitive electrical equipment.

### SUMMARY OF INVENTION

The present invention is described hereinafter by various embodiments. This invention may, however, be embodied in many different forms and should not be construed as limited to the embodiment set forth herein.

According to an aspect of the invention, a system for protection of solid state electrical devices such as luminaires against over and/or under voltage conditions is provided. The system comprises an AC input, supplying an AC, connected with one or more fuses, one or more AC filters, connected with the AC input via the one or more fuses, configured to filter the inconsistent frequencies from the AC thereby converting AC voltage into AC line voltage one or more rectifiers, connected with the one or more AC filters, configured to convert the AC line voltage into DC line voltage thereby forming a DC bus voltage one or more buck converters, connected with the one or more rectifiers, configured to step down the DC bus voltage thereby providing a first DC voltage, one or more voltage dividers, connected with the one or more rectifiers, configured to divide the DC bus voltage into a plurality of DC voltages lower than the DC bus voltage, thereby providing a second DC voltage and a third DC voltage, a threshold detector connected with the one or more buck converters and the one or more voltage dividers, comprising a detector means, a first voltage comparator and a second voltage comparator, a relay connected with the threshold detector, the AC input supplying the AC and one or more loads such as one or more luminaires. Further, the first DC voltage from the one or more buck converters is powering the detector means incorporated inside the threshold detector. Henceforth, the detector means is configured to provide a reference voltage and compare the second DC voltage and the third DC voltage with the reference voltage. In addition, the second DC voltage is above the reference voltage, the first voltage comparator is configured to signal the relay. Additionally, the third DC voltage is below the reference voltage, the second voltage comparator is configured to signal the relay. Moreover, the relay, on reception of signal from the threshold detector, is configured to cut off the AC input thereby stopping the flow of AC to the one or more loads preferably the one or more luminaires. Further, the second DC voltage is below the reference voltage and the third DC voltage is above the reference voltage, the relay is configured to resume the flow of AC to the one or more loads preferably the one or more luminaires. Moreover, the reference voltage is a fixed voltage indicating the voltage of the AC input, ranging from 80 V to 450 V, safe for the one or more loads preferably the one or more luminaires.

In accordance with an embodiment of the present invention, the system further includes a third voltage comparator for an additional layer of protection, connected with the AC filters and the relay, configured to compare the AC line voltage with a predetermined voltage, activates in the case of abrupt or sudden high voltage and in the case of non-activation or failure of the First voltage comparator.

In accordance with an embodiment of the present invention, the AC line voltage is above the predetermined voltage, the third voltage comparator i.e. an additional layer protection circuit. is further configured to signal the relay thereby cutting off the AC input thus stopping the flow of AC to the one or more loads preferably the one or more luminaires.

In accordance with an embodiment of the present invention, the relay is configured to switch into one of ON and OFF condition.

In accordance with an embodiment of the present invention, the threshold detector, on detecting the second DC voltage as below the reference voltage and the third DC voltage as above the reference voltage, the relay in the ON condition, allowing the flow of current from the AC input to the one or more loads, preferably the one or more luminaires.

In accordance with an embodiment of the present invention, the threshold detector, on detecting the second DC voltage above the reference voltage, the relay in the OFF condition, cutting off the flow of current from the AC input to the one or more loads, preferably the one or more luminaires.

In accordance with an embodiment of the present invention, the threshold detector, on detecting the third DC voltage below the reference voltage, the relay in the OFF condition, cutting off the flow of current from the AC input to the one or more loads, preferably the one or more luminaires.

In accordance with an embodiment of the present invention, the AC line voltage is above the predetermined voltage, the relay in the OFF condition, cutting off the flow of current from the AC input to the one or more loads, preferably the one or more luminaires.

In accordance with an embodiment of the present invention, the threshold detector comprising a first assembly of IC, a detector means such as a detector IC, a first plurality of resistors, a first plurality of capacitors and a first plurality of Zener diodes and first plurality of reference voltage shunt regulators.

In accordance with an embodiment of the present invention, the one or more voltage dividers comprises of a second plurality of resistors, a second plurality capacitors and a second plurality of Zener Diodes.

In accordance with an embodiment of the present invention, the one or more buck converters comprising a second assembly of IC, a plurality of inductors, a plurality of diodes, a third plurality of Zener diodes, a low dropout regulator (LDO), a third plurality of capacitors and a third plurality of resistors.

### BRIEF DESCRIPTION OF DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments.

These and other features, benefits and advantages of the present invention will become apparent by reference to the following text FIGURE, with like reference numbers referring to like structures across the views, wherein:

FIG. 1 illustrates a system for protection of electrical devices, in accordance with an embodiment of the present invention.

### DETAIL DESCRIPTION OF THE DRAWINGS

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain FIGURES, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by is the appended claims. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

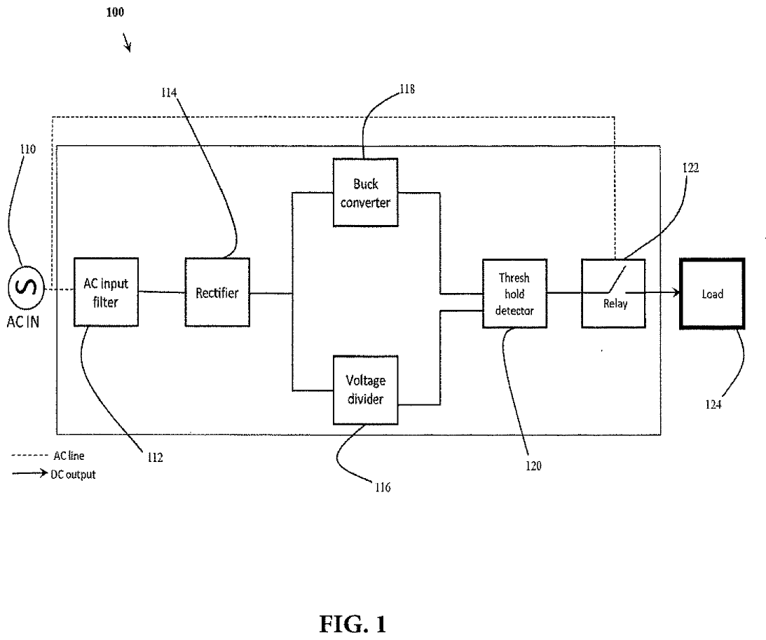

FIG. 1 illustrates a system (100) for protection of electrical devices, in accordance with an embodiment of the present invention. The electrical devices (not shown) may be, but not limited to, luminaires. In general, the electrical devices such as luminaires may damage during voltage fluctuation, therefore require protection during both over voltage and under voltage conditions. As shown in FIG. 1, the system (100) comprises an AC input (110) that is connected with one or more AC input filters (112). Further, the AC input (110) may be connected with one or more fuses. The AC input may be but not limited to, single phase, phase to phase. The one or more AC input filters (112) comprises, but not limited to, capacitor and inductor. The one or more AC input filters (112) may be connected with one or more rectifiers (114) in parallel and/or series. The one or more rectifiers (114) may be connected with one or more buck converters (118). The one or more buck converters (118) comprise, but not limited to, assembly of Integrated circuit (IC), Zener diodes, LDO, capacitors, resistors connected in parallel and/or in series. The one or more rectifiers (114) are further connected with one or more voltage dividers (116) respectively. In addition, the one or more voltage dividers (116) comprise respective resistors, respective capacitors and respective Zener diodes.

The one or more buck converters (118) and the one or more voltage dividers (116) may be connected in, but not limited to, parallel or series with the one or more rectifiers (114). Further, the one or more buck converters (118) and/or the one or more voltage dividers (116) may be connected with one or more threshold detectors (120). The one or more threshold detectors (120) may have, but not limited to, a respective a detector means for example a detector IC (integrated circuit), a first voltage comparator and a second voltage comparator. The one or more threshold detectors (120) may be connected with one or more relays (122). Each of the one or more relays (122) may be, but not limited to, a solid state relay (SSR), Single Pole Single Throw (SPST). The one or more relays (122) may have, but not limited to, one or more outputs and may be connected with a load (124). Also, the AC Input is connected with the one or more relays (122). Further, the system (100) may include a third voltage comparator i.e. an additional layer protection circuit, connected with the AC filters (112) and the relay (122).

The present invention works in the following manner.

For better explanation, the exemplary embodiment of the system (100) is envisaged to include the AC input (110), one fuse, one AC input filter (112), one rectifier (114), one buck converter (118), two voltage dividers (116), one threshold detector (120), one relay (122) and the load (124). The current from the AC input (110) is first filtered in the AC input filter (112). The fuse connected to the AC input (110) may be configured to provide protection against over current conditions where the AC input (110) current may be more than the bearing capacity of the system (100). Preferably, protection of the circuitry of the system (100) including the AC input filter (112), the rectifier (114), the buck converter (118), two voltage dividers (116), the threshold detector (120) and the relay (122) from the overcurrent (input current) conditions say, for example, more than may be but not limited to AC input with current=3.15 A, voltage=500 Volts. The AC input filter (112) is configured to convert an AC voltage to filtered AC line voltage. The filtered AC line voltage may further be converted into a DC Bus voltage using the rectifier (114). Then, the buck converter (118) is configured to step down the DC Bus voltage and reduce any remaining inconsistencies in the current and the voltage, there by generating a first DC voltage. In addition, the voltage divider (116) is configured to divide the DC bus voltage into a plurality of DC voltages lower than the DC bus voltage, thereby providing a second DC voltage and a third DC voltage.

The first DC voltage output from the buck converter (118) is configured to power up the detector IC incorporated inside the threshold detector. The detector IC is configured to provide a reference voltage and compare the second DC voltage and the third DC voltage with the reference voltage. The reference voltage is a fixed voltage indicating the voltage of the AC input (110), ranging from 80 V to 450 V, safe for the one or more loads (124) preferably the one or more luminaires.

In case, the second DC voltage as above the reference voltage, the first voltage comparator is configured to signal the relay (122). Whereas, on detecting the third DC voltage below the reference voltage, the second voltage comparator is configured to signal the relay (122). The relay (122), on reception of signal from the threshold detector (120), is configured to cut off the AC input (110) thereby stopping the flow of AC to the one or more loads (124) preferably the one or more luminaires. Further, when the second DC voltage is below the reference voltage and the third DC voltage is above the reference voltage, the relay (122) is configured to resume the flow of AC to the one or more loads (124) preferably the one or more luminaires.

The relay (122) is actuated on receiving the one or more signals from threshold detector (120) and the relay (122) is configured to switch into one of ON and OFF conditions. The threshold detector (120), on detecting the second DC voltage as below the reference voltage and the third DC voltage as above the reference voltage, the relay (122) switch into the ON condition allowing the flow of current from the AC input (110) to the one or more loads (124), preferably the one or more luminaires.

The threshold detector (120), on detecting the second DC voltage above the reference voltage, the relay (122) switch into the OFF condition, cutting off the flow of current from the AC input (110) to the one or more loads (124), preferably the one or more luminaires. The threshold detector (120), on detecting the third DC voltage below the reference voltage, the relay (122) in the OFF condition, cutting off the flow of current from the AC input (110) to the one or more loads (124), preferably the one or more luminaires.

The relay (122) is configured to control the current from AC input (110) to the load (124) switching between connection and disconnection with the load (124). The system (100) is designed for a fast response time. The time delay is ≤10 ms to timely protect the connected load (124) preferably, the luminaires. The system (100) is transformer less design and may have an offline buck converter for AC-DC conversion. The system (100) may have inbuilt self-surge protection in both common mode and differential mode.

Further, a third voltage comparator i.e. an additional layer protection circuit may be connected with the AC filters (112) and the relay (122). The third voltage comparator is configured to compare the AC line voltage with a predetermined voltage which may be an indicator of sudden over voltage (over 320 Volts) occurring abruptly for example, where a sudden swell in voltage occurs when the load is connected with the AC input (110). In case, the AC line voltage is above the predetermined voltage, the third voltage comparator may signal the relay (122). The relay may turn OFF thereby cutting off the AC input (110) and stopping the flow of AC to the one or more loads (124) preferably the one or more luminaires. In case the AC line voltage is above the predetermined voltage, the relay (122) in the OFF condition, cutting off the flow of current from the AC input (110) to the one or more loads (124), preferably the one or more luminaires.

The present invention has various advantages. The system provides a cost effective and easy to implement solution to the problems of prior art. The present invention provides protection to small electrical devices such as luminaires against voltage fluctuations. The present invention not only provides protection against over voltage but also against under voltage. The system cuts off the power supply to the electrical devices in case of over and/or under voltage. This in turn can increase the life cycle of such electrical devices. The system is designed for a fast response time. The time delay is ≤10 ms to timely protect the connected load preferably, the luminaires. The system is transformer less design and have an offline buck converter for AC-DC conversion. The regulated supply makes it more accurate and reliable.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention.

We claim:

1. A system (100) for protection of solid state electrical devices such as luminaires against over and/or under voltage conditions, comprising:
an AC input (110), supplying an AC, connected with one or more fuses;
one or more AC filters (112), connected with the AC input (110) via the one or more fuses, configured to filter the inconsistent frequencies from the AC thereby converting AC voltage into AC line voltage;
one or more rectifiers (114), connected with the one or more AC filters (112), configured to convert the AC line voltage into DC line voltage thereby forming a DC bus voltage;
one or more buck converters (118), connected with the one or more rectifiers (114), configured to step down the DC bus voltage thereby providing a first DC voltage;
one or more voltage dividers (116), connected with the one or more rectifiers (114), configured to divide the DC bus voltage into a plurality of DC voltages lower than the DC bus voltage, thereby providing a second DC voltage and a third DC voltage;
a threshold detector (120) connected with the one or more buck converters (118) and the one or more voltage dividers (116), comprising a detector means, a first voltage comparator and a second voltage comparator;
a relay (122) connected with the threshold detector (120), the AC input (110) supplying the AC and one or more loads (124) such as one or more luminaires;
wherein the first DC voltage from the one or more buck converters (118) is powering the detector means incorporated inside the threshold detector (120);
wherein the detector means is configured to provide a reference voltage and compare the second DC voltage and the third DC voltage with the reference voltage;
wherein the second DC voltage is above the reference voltage, the first voltage comparator is configured to signal the relay (122);
wherein the third DC voltage is below the reference voltage, the second voltage comparator is configured to signal the relay (122);
wherein the relay (122), on reception of signal from the threshold detector (120), is configured to cut off the AC input (110) thereby stopping the flow of AC to the one or more loads (124) preferably the one or more luminaires;
wherein the second DC voltage is below the reference voltage and the third DC voltage is above the reference voltage, the relay (122) is configured to resume the flow of AC to the one or more loads (124) preferably the one or more luminaires;
wherein the reference voltage is a fixed voltage indicating the voltage of the AC input (110), ranging from 80 V to 450 V, safe for the one or more loads (124) preferably the one or more luminaires.

2. The system (100) as claimed in claim 1, further including a third voltage comparator for an additional layer of protection, connected with the AC filters (112) and the relay (122), configured to compare the AC line voltage with a predetermined voltage, activates in the case of abrupt or sudden occurrence of high voltage and in the case of non-activation or failure of the First voltage comparator.

3. The system (100) as claimed in claim 2, wherein the AC line voltage is above the predetermined voltage, the third voltage comparator is further configured to signal the relay (122) thereby cutting off the AC input (110) thus stopping the flow of AC to the one or more loads (124) preferably the one or more luminaires.

4. The system (100) as claimed in claim 1, wherein the relay (122) is configured to switch into one of ON and OFF condition.

5. The system (100) as claimed in claim 1, wherein the threshold detector (120), on detecting the second DC voltage as below the reference voltage and the third DC voltage as above the reference voltage, the relay (122) in the ON condition, allowing the flow of current from the AC input (110) to the one or more loads (124), preferably the one or more luminaires.

6. The system (100) as claimed in claim 1, wherein the threshold detector (120), on detecting the second DC voltage above the reference voltage, the relay (122) in the OFF condition, cutting off the flow of current from the AC input (110) to the one or more loads (124), preferably the one or more luminaires.

7. The system (100) as claimed in claim 1, wherein the threshold detector (120), on detecting the third DC voltage below the reference voltage, the relay (122) in the OFF condition, cutting off the flow of current from the AC input (110) to the one or more loads (124), preferably the one or more luminaires.

8. The system (100) as claimed in claim 2, wherein the AC line voltage is above the predetermined voltage, the relay (122) in the OFF condition, cutting off the flow of current from the AC input (110) to the one or more loads (124), preferably the one or more luminaires.

9. The system (100) as claimed in claim 1, wherein the threshold detector (120) comprising a first assembly of IC, a detector means such as a detector IC, a first plurality of resistors, a first plurality of capacitors and a first plurality of Zener diodes and first plurality of reference voltage shunt regulators.

10. The system (100) as claimed in claim 1, wherein the one or more voltage dividers (116) comprises of a second plurality of resistors, a second plurality capacitors and a second plurality of Zener Diodes.

11. The system (100) as claimed in claim 1, the one or more buck converters (118) comprising a second assembly of IC, a plurality of inductors, a plurality of diodes, a third plurality of Zener diodes, a low dropout regulator (LDO), a third plurality of capacitors and a third plurality of resistors.
